(19) United States
(12) Patent Application Publication
(10) Pub. No.: US 2012/0150436 A1
(43) Pub. Date: Jun. 14, 2012

(54) Method for Displaying a Travel Route

(75) Inventors: Gerardo Rossano, Braunschweig (DE); Anna Korina Loumidi, Braunschweig (DE)

(73) Assignees: VOLKSWAGEN AG, Wolfsburg (DE); AUDI AG, Ingolstadt (DE)

(21) Appl. No.: 12/964,999

(22) Filed: Dec. 10, 2010

(51) Int. Cl. G01C 21/36

(52) U.S. Cl. 701/450; 701/425

(57) ABSTRACT

A method for displaying a travel route on a display screen in a vehicle includes plotting location names in a linear manner horizontally across the display screen. A travel route is displayed by plotting items of travel route information in a linear manner horizontally across the display screen, wherein the travel route information is a time information or a distance information. Each location name and a respective one of the items of travel route information are aligned in a vertical direction. A graphical symbol for the vehicle is displayed on the display screen such that a position of the graphical symbol for the vehicle indicates a current position of the vehicle along the travel route. The location names and the travel route information are updated as the vehicle travels along the travel route.

### BACKGROUND OF THE INVENTION

### Field of the Invention

The invention relates to a method for displaying a travel route on a display screen in a vehicle.

Conventional navigation systems provide information to a driver about route maneuvers, arrival information, landmarks, points of interest, traffic, and events along the driver's calculated route of travel and on various other road arteries shown on a map view. Some conventional navigation systems even show weather data plotted as a topographic overlay on the map. A disadvantage of such conventional navigation systems that provide information about route maneuvers, arrival information, landmarks, points of interest, traffic conditions, current events and the weather is that it is sometimes difficult to interpret certain types of information when presented in a graphical manner overlaying the traditional plan view of the navigation map. A further disadvantage of such navigation systems is that it can be visually and cognitively demanding to determine which of the items of information shown on a display will impact the driver's current trip and which items will have no impact on the driver's current trip. Another disadvantage of such navigation systems is that it may be difficult for the driver to determine at what time a given item of information may have an impact on the current trip, especially if that information is based on some predicted conditions along the driver's route. These demands on the driver's attention may contribute to distracting the driver from the task of operating the vehicle.

German Patent Application Publication No. DE 10 2007 037 938 A1 discloses a conventional navigation system for a motor vehicle. The navigation system has a receiver for receiving messages about current traffic-relevant events and predicted traffic-relevant events. A traffic-relevant event may for example be a thunderstorm that is predicted to occur at a given time and location along a travel route. The traffic-relevant events have location information objects and time information objects assigned thereto. A display device displays a road map or route map and graphics objects assigned to the messages. The graphics objects may be icons indicating traffic-relevant events. A travel route may be displayed in a simplified form by displaying the road map and the roads along the travel route in a linearized form. Important crossroads, important locations and landmarks may be added to the simplified display of the travel route in order to facilitate orientation. Based on so-called time information objects that are assigned to respective messages, the messages are preferably assigned to a corresponding time slice. When selecting one or more successive time slices, the associated messages are selected together with the respective time slices. Graphic objects that correspond to location information objects are preferably displayed as icons that are superimposed on the route map.

Driver distraction resulting from the use of navigation systems while operating a vehicle has increased with the ever-increasing amount of information that is made available to the driver and the passengers. These distractions interfere with the driver's ability to focus on the task of driving. In particular, visual distractions that require the driver to take his or her eyes off the road reduce the driving performance and may increase the risk of accidents. Furthermore, tasks that are performed concurrently, such as operating a navigation system on the dashboard of the vehicle while performing the primary task of driving, can have a negative effect on the ability to perform the two tasks in a satisfactory manner.

Conventional navigation systems as described above are visually and cognitively demanding and may disadvantageously interfere with the driver's ability to perform the primary task of driving the vehicle. As the use of Internet-connected devices, GPS-enabled devices, cell phones and other mobile devices increases, information is becoming increasingly pervasive in the lives of the users of such devices. Vehicles are no exception, with many cars offering information services in the vehicle.

Information provided to the driver of a vehicle has increased with the increasing availability of information services that are offered for example by navigation systems and other systems which are available in many vehicles. Since the amount of information that is made available to the driver is likely to increase in the future, there is a need for improved methods and systems for providing information to a driver.

### SUMMARY OF THE INVENTION

It is accordingly an object of the invention to provide a method for displaying a travel route which overcomes the above-mentioned disadvantages of the heretofore-known methods of this general type and which provides a driver with information that the driver needs to safely navigate to a destination without distracting the driver from the task of driving.

With the foregoing and other objects in view there is provided, in accordance with the invention, a method for displaying a travel route, which includes the steps of:

providing a display screen in a vehicle, the display screen defining a first direction and a second direction, the first direction extending substantially horizontally, the second direction extending substantially perpendicular to the first direction;

plotting, in a first portion of the display screen, location names in a linear manner along the first direction, wherein the first portion of the display screen extends horizontally across the display screen;

plotting a travel route in a linear manner in a second portion of the display screen by plotting items of travel route information in a linear manner along the first direction, wherein a respective one of the location names in the first portion of the display screen and a respective one of the items of travel route information in the second portion of the display screen are aligned in the second direction, wherein the second portion of the display screen extends horizontally across the display screen and wherein the travel route information is selected from the group including time information and distance information;

displaying a graphical symbol for the vehicle in the second portion of the display screen such that a position of the graphical symbol for the vehicle indicates a current position of the vehicle along the travel route; and

updating the location names and the travel route information as the vehicle travels along the travel route.

An advantage of displaying travel route information in a linear manner as defined above is that multiple pieces of information and how the pieces of information are associated with one another are easy to comprehend with just one glance at the display screen. Driver distraction is thus reduced and driving safety is increased.

Another mode of the invention includes the steps of providing the first portion of the display screen as an upper portion of the display screen and providing the second portion of the display screen as a lower portion of the display screen such that the upper portion of the display screen and the lower portion of the display screen extend adjacent one another horizontally across the display screen; and providing a message window in a bottom portion of the display screen, wherein the bottom portion of the display screen is located below the lower portion of the display screen.

Another mode of the invention includes the steps of plotting the travel route by plotting the items of travel route information in a linear manner from left to right horizontally across the second portion of the display screen; displaying the graphical symbol for the vehicle at a fixed position on a left side of the second portion of the display screen; and moving the location names in the first portion of the display screen from right to left as the vehicle travels along the travel route.

Another mode of the invention includes the steps of displaying a graphical symbol for an event related to the travel route, the event being selected from a group including a traffic-related event, a weather-related event, an environmental event, a road condition, a point of interest, and a happening; and positioning the graphical symbol for the event in accordance with a time information or a distance information associated with the event.

Another mode of the invention includes the steps of providing the display screen as a touch-sensitive display screen; providing the graphical symbol for the event as a touch-selectable graphical symbol on the display screen; and displaying detail information about the event in response to the touch-selectable graphical symbol being selected, wherein the detail information is displayed in a message window in a bottom portion of the display screen, and wherein the bottom portion of the display screen is located below the lower portion of the display screen. In addition or as an alternative to an interface of a touch-sensitive display screen, it is possible to provide a control such that detail information is displayed in response to actuating a button or switch or in response to a voice command.

Another mode of the invention includes the steps of providing the display screen as a touch-sensitive display screen; displaying a graphical symbol indicative of a weather condition at a given location along the travel route, wherein the graphical symbol indicative of the weather condition is placed adjacent to a corresponding one of the location names in the first portion of the display screen; providing the graphical symbol indicative of the weather condition and/or the corresponding one of the location names as a touch-selectable region on the display screen; and displaying detailed weather information in response to the touch-selectable region on the display screen being selected.

Another mode of the invention includes the step of displaying, as the travel route information plotted in the second portion of the display screen, a relative time to reach a location along the travel route, wherein the relative time to reach the location and a corresponding one of the location names are aligned in the second direction.

Another mode of the invention includes the step of displaying, as the travel route information plotted in the second portion of the display screen, a relative distance to reach a location along the travel route, wherein the relative distance to reach the location and a corresponding one of the location names are aligned in the second direction.

Another mode of the invention includes the step of tracking a position of a further vehicle traveling along the travel route by displaying a graphical symbol for the further vehicle and positioning the graphical symbol for the further vehicle in accordance with a time information or a distance information associated with the further vehicle. In other words, the graphical symbol for the further vehicle is placed at a position along the plotted travel route on the display screen that corresponds to the current actual position of the further vehicle.

Another mode of the invention includes the steps of displaying a graphical symbol for indicating travel route conditions, the travel route conditions being selected from a group including road conditions and weather conditions; and providing the graphical symbol for the travel route conditions as a continuous band extending horizontally across the display screen such that respective sections of the continuous band indicate respective travel route conditions along respective sections of the travel route.

Another mode of the invention includes the step of plotting the travel route in a linear manner, wherein the travel route is presented in the absence of a two-dimensional navigation map on the display screen.

Another mode of the invention includes the steps of providing a further display screen in the vehicle, wherein the further display screen is located in an instrument cluster; and displaying turn-by-turn directions on the further display screen.

Another mode of the invention includes using, as the display screen provided in the vehicle, a factory-installed display screen. The factory-installed display screen may for example be the main display screen of a factory-installed infotainment system.

Another mode of the invention includes using, as the display screen provided in the vehicle, a display screen of a portable navigation device. The portable navigation device may for example be a dedicated portable navigation device or a mobile phone that offers navigation functions.

Other features which are considered as characteristic for the invention are set forth in the appended claims.

Although the invention is illustrated and described herein as embodied in a method for displaying a travel route, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a plan view of a conventional navigation map illustrating a method for displaying traffic information on a two-dimensional navigation map in accordance with the prior art;

FIG. 2 is a diagrammatic perspective view of a vehicle interior having display screens in accordance with the invention; and

FIGS. 3 to 10 are diagrammatic views of exemplary embodiments of display screens displaying a trip overview for a travel route in accordance with the invention.

### DESCRIPTION OF THE PREFERRED EMBODIMENTS

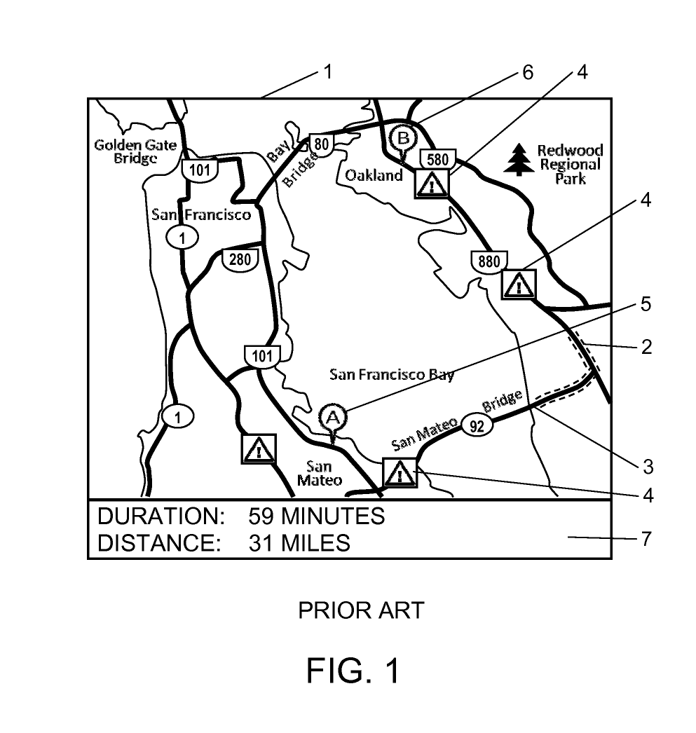

Referring now to the figures of the drawings in detail and first, particularly, to FIG. 1 thereof, there is shown a typical prior art plan view of a navigation map which illustrates a method for displaying traffic information on a map. As explained above, navigation systems provide information to the driver about route maneuvers, arrival information, landmarks, points of interest, traffic, and events along a calculated travel route or on various other road arteries shown on a map view. A disadvantage of a navigation map as shown in FIG. 1 is that it may be difficult for a driver to interpret certain types of information when presented in a graphical manner overlaying the plan view navigation map while at the same time having to concentrate on the task of driving.

FIG. 1 shows a typical prior art plan view of a navigation map 1 which illustrates a method for displaying traffic information on a map. There are generally two types of traffic information. First, traffic flow conditions reflect congestion on main arteries. These traffic flow conditions are often presented in terms of a traffic flow rate. For example, the traffic flow rate in FIG. 1 is indicated by dashed lines 2 along both sides of a road artery 3. The traffic flow conditions indicated by the dashed lines 2 that overlay the respective road arteries 3 may alternatively be shown as color-coded lines. A green line may indicate a high traffic flow rate or low congestion, an orange line may indicate a moderate traffic flow rate or moderate congestion and a red line may indicate a low traffic flow rate or high congestion. Second, traffic information is also presented as events such as accidents and construction zones. In FIG. 1 this information is represented by the traffic alert icons 4.

FIG. 1 also shows a starting point A and a destination point B of a route from San Mateo to Oakland. The starting point A of the route in San Mateo is indicated by a placemark 5. The destination point B of the route in Oakland is indicated by a placemark 6. The route that is calculated by the navigation system may in this case include portions of U.S. Route 101, State Route 92 and Interstate 880. On a color display of a conventional navigation system, the route between point A and point B would preferably be highlighted in a certain color. Looking at the navigation map 1 shown in FIG. 1, a driver would expect a high traffic flow rate for part of the calculated route as indicated by the dashed lines 2. For a driver it is however difficult to interpret the traffic flow on the route segment indicated by the dashed lines 2. Furthermore, there are three traffic alert icons 4 on the route. With the information presented in this manner, it is difficult to estimate when the driver can expect to run into these events in terms of relative time and/or relative distance, and what impact the events will have on the overall duration of the trip.

In a bottom region 7 of the navigation map 1 of FIG. 1 is the trip information that accompanies the navigation map, namely the duration of the trip and the distance between the starting point and the destination point of the route. The trip information is given only for the final destination in terms of the total trip duration and the total distance. In the prior art example shown in FIG. 1, the trip information at the bottom of the navigation map does not include any intermediate details or any specific information about the traffic events indicated by the traffic alert icons 4 and about possible traffic congestion caused by traffic events. If the information provided to the driver includes only the total trip duration and the total distance, it is difficult to estimate at what time specific events will impact the driver's planned trip and how severely specific events will impact the planned trip.

In addition to the prior art navigation map shown in FIG. 1, there are further conventional methods and systems for providing trip information with the help of portable devices, online tools, and automotive navigation systems. These conventional systems may display a variety of information that is relevant for a calculated route. The conventional systems generally display information that is relevant for a calculated route either in the form of a list that is displayed separate from the navigation map or in the form of a graphic overlay similar to the prior art example shown in FIG. 1. The information that is relevant for the calculated route is in this case provided in a manner such that the driver cannot readily see when specific events will occur during the trip, or what the impact could be to the driver.

The method according to the invention achieves the object of improving the presentation of information to the driver by merging and displaying driver-relevant information along a calculated route of travel in a substantially linear manner. Such driver-relevant information may include current weather conditions, predicted weather conditions, current traffic conditions, predicted traffic conditions, road conditions, and events. The graphical representation of the data related to current and predicted conditions and events is plotted in a linear manner according to locations along the route. For example, locations such as the current position of the driver's vehicle, stopovers, landmarks, and destinations are merged with weather and traffic data, road conditions, and events, and then plotted in terms of a so-called “relative time to reach” and a “relative distance to reach”, i.e. a calculated time duration to reach a specific location or event along the route and a distance of travel required before the driver reaches the specific location or event. This type of information representation offers the possibility to reduce driver distraction when using a navigation system by providing an easy and clear trip overview to the driver that discards superfluous information often shown on navigation maps of conventional navigation systems.

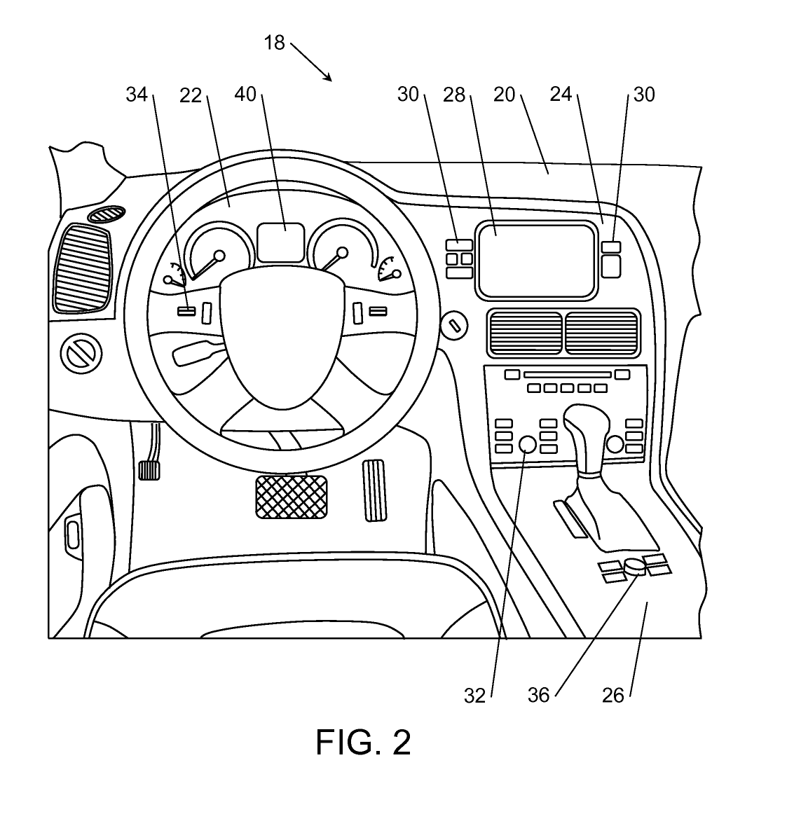

FIG. 2 shows in an exemplary manner a vehicle interior 18 having a main display screen 28 which operates as a display screen for a navigation system and which is configured to display trip overview information in accordance with the invention. Instead of using a factory-installed display screen that is fixedly mounted in the vehicle, it is also possible to use a display screen of a portable navigation device. The portable navigation device may be a dedicated portable navigation device or any other portable device that can provide suitable navigation functions, such as a mobile phone providing navigation functions.

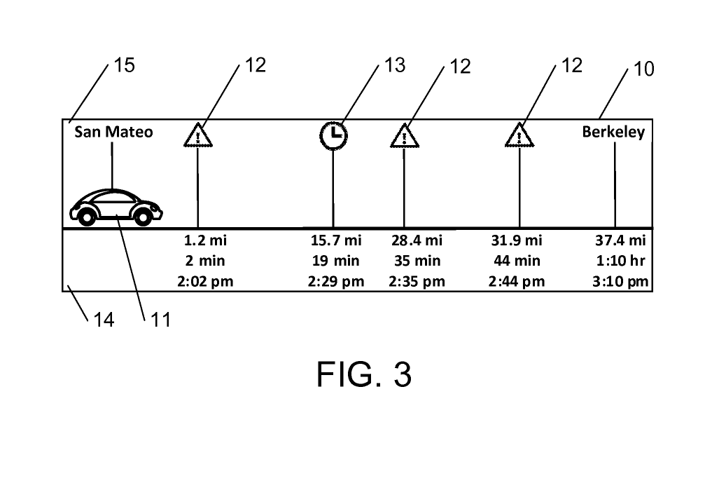

FIG. 3 shows an exemplary embodiment of a display screen 10 in accordance with the invention. FIG. 3 illustrates the general principle of a graphical arrangement of information on a display screen 10 wherein the display screen provides in this case a trip overview for a trip from San Mateo to Berkeley. In the graphical arrangement of information shown in FIG. 3, time information and distance information are given for the final destination (Berkeley) as well as for each event that may be encountered along the calculated route. The driver's current position is graphically indicated by the vehicle icon 11 on the left side of the display screen 10. The current position is furthermore textually indicated by a location name above the vehicle icon 11. The final destination is textually indicated on the right side of the display screen 10.

The driver will in this case be informed that traffic events such as accidents or construction sites, are to be expected along the route at a distance of 1.2 miles, 28.4 miles and 31.9 miles from the current position. The driver will also be informed that a traffic congestion is to be expected at a distance of 15.7 miles from the driver's current position. The traffic events and the traffic congestion are indicated by pictograms. The traffic events are in this case indicated by warning triangles 12. The traffic congestion is in this case indicated by a pictogram of a clock 13. In the bottom portion 14 of the display screen 10, travel route information or trip information relating to the traffic events, which are indicated by the pictograms 12, 13, is provided. The respective travel route information or trip information relating to each respective traffic event is located below the respective pictogram for the respective traffic event such that each respective pictogram and the respective trip information are aligned in a vertical direction. Aligning a pictogram and the related trip information in a vertical direction visually connects the pictogram to the related information and thus facilitates comprehension of the presented information. The pictogram of a traffic event, which is displayed in the top portion 15 of the display screen 10, and the corresponding trip information for the traffic event, which is shown in the bottom portion 14 of the display screen 10, are furthermore visually connected by a vertical line.

The display screen 10 shown in FIG. 3 informs the driver that there will be a traffic event in 1.2 miles corresponding to a calculated driving time of two minutes and that the driver will encounter the traffic event at 2:02 pm. The display screen also informs the driver that after a driving time of 19 minutes, a traffic congestion is to be expected in 15.7 miles at 2:29 pm. The display screen furthermore informs the driver that in 28.4 miles, which corresponds to a calculated driving time of 35 minutes, a traffic event is to be expected that at 2:35 pm. The display screen furthermore informs the driver that in 31.9 miles, which corresponds to a driving time of 44 minutes, a traffic event is to be expected that at 2:44 pm. The display screen shown in FIG. 3 informs the driver that the distance to the final destination, which in this case is Berkeley, is 37.4 miles corresponding to a driving time of one hour and ten minutes and that the driver a will arrive at the final destination at 3:10 pm.

The information displayed on the display screen 10 is updated in order to provide current trip information. As a result of the trip information or travel route information being provided as shown in FIG. 3, the driver does not need to estimate time and distance to the traffic events. Due to the fact that the trip information related to traffic events that occur in a chronological order is displayed in a sequence along a horizontal axis it is easy for the driver to get an overview of the traffic events between the starting location and the destination location.

The trip overview information as shown in FIG. 3 eliminates the uncertainty regarding the driver's relative time and relative distance to reach a traffic event, the relative time and relative distance to encounter weather conditions or road conditions, and the relative time and relative distance to be affected by other traffic data or events along the calculated route. The driver therefore does not have to guess the relative time or relative distance to reach traffic events along the travel route. Additionally, plotting the data in a linear manner along a horizontal axis as shown in FIG. 3 eliminates the displaying of superfluous information that may not be of interest or relevant to the driver's current route of travel. The elimination of superfluous or irrelevant information from the display screen makes it easier for the driver to comprehend the relevant information in a short period of time. This reduces the cognitive load of the driver and allows the driver to concentrate on the task of driving.

Map information and trip information such as surrounding road arteries, events that are close to the driver's route but not on the driver's route, and terrain information is information that is not essential to the trip and is most likely of little use to the driver. Further, information about neighboring cities that are not on the driver's route is not essential to the trip whereas information about landmark cities along the calculated route is essential information that helps the driver identify his or her own position in relation to the final destination and other indicated events along the route. One of the elements that is missing from the current depiction of the trip information on the display screen shown in FIG. 3 is information about required turns along the route that the driver will need to perform in order to reach his/her destination. This information, however, is not pertinent to the driver's trip overview and therefore need not be displayed on the display screen. The main intention of the trip overview is to provide the driver with information about weather and traffic data, road conditions, and events along the route calculated in terms of the relative time to reach the respective events and conditions and in terms of the relative distance to reach the events and conditions.

If the driver needs navigation information in the form of turn-by-turn instructions or in the form of a route that is highlighted on a map, then the driver can switch the display screen 10 to a map view or a list view and can acquire the necessary information about the turns that need to be made during navigation by viewing a conventional plan view map and/or by viewing turn-by-turn instructions provided in a list format.

As an alternative to switching the display screen 10 from the trip overview view according to the invention to a map view or a list view, it is also possible to provide the map view and/or the list view on a separate display screen in a vehicle. An exemplary embodiment of a vehicle interior 18 having two separate display screens 28, 40 is shown in FIG. 2. The vehicle interior 18 includes a dashboard 20 with an instrument cluster 22, a center stack 24 and a center console 26. The center stack 24 includes a main display screen 28 which is configured to operate as a display for a navigation system, a climate control system, and a multimedia system. The main display screen 28 may be a touchscreen such that a driver or passenger can input information by touching the main display screen 28. Additionally or alternatively push buttons 30, rotary dials 32, scroll wheels 34, and a rotary-push knob 36 may provide input functions. The instrument cluster 22 has a centrally located instrument cluster display screen 40 which can be used to show navigation information. For example, the main display screen 28 located on the center stack 24 of the vehicle may present the trip overview information in accordance with the invention, whereas the instrument cluster display screen 40 may present a list view of the turn-by-turn instructions. This setup will allow the driver to have access to both the turn-by-turn directions in the instrument cluster display screen 40 and the trip overview information on the main display screen 28 at the same time. By displaying different information on different display screens located on the instrument cluster 22, the center stack 24 or possibly even the center console 26, it is possible to maximize the use of all available displays in the vehicle, showing the most immediately needed information, such as turn directions, on the instrument cluster display screen 40, while showing all other needed information on the main display screen 28 of the vehicle. Another advantage of using the above described setup is that information that is relevant to mostly the driver, such as the turn-by-turn directions, is presented on the instrument cluster display screen 40 directly in front of the driver. The driver can see the driver-relevant information without having to turn his/her head. Information that is more beneficial for all passengers in the vehicle, such as the trip overview information, is presented on the main display screen 28 which is in the field of vision of all passengers.

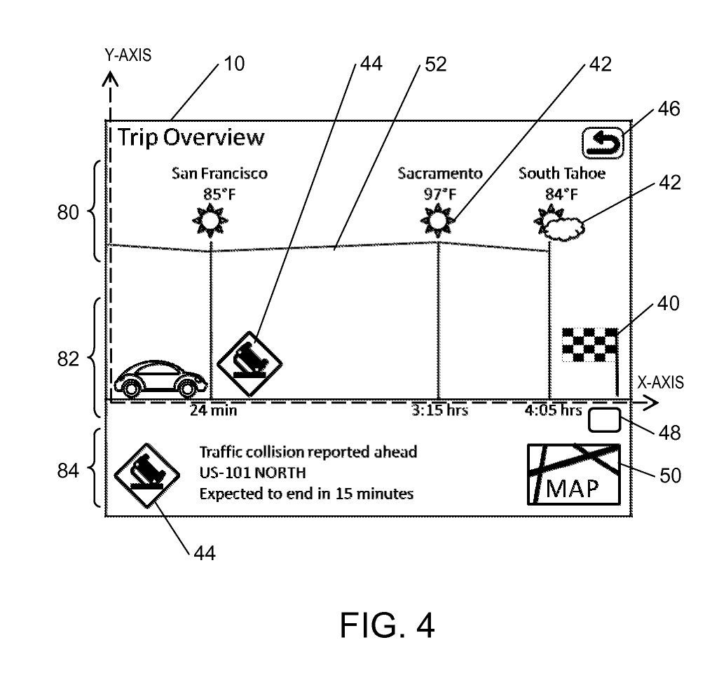

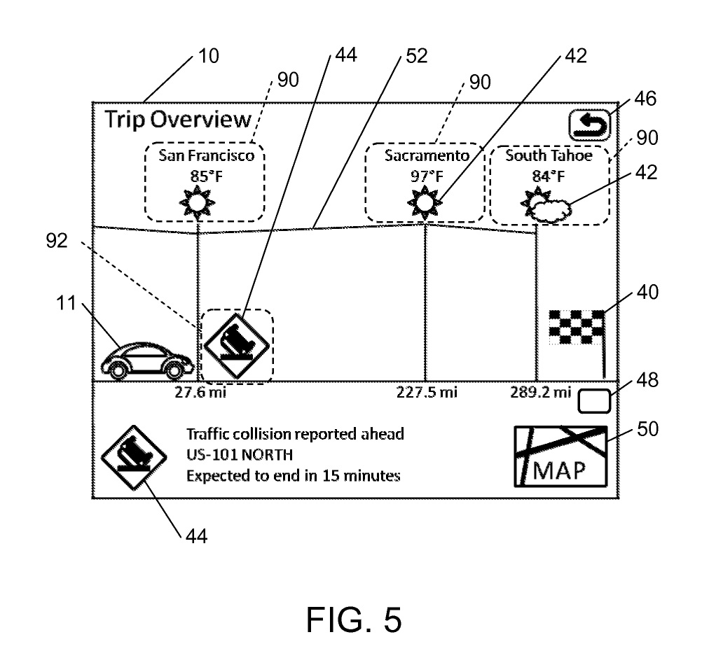

FIGS. 4 and 5 illustrate in an exemplary manner an implementation of the trip overview view on a display screen 10 which is preferably the main display screen 28 in the vehicle interior 18. Similar to the exemplary embodiment described with reference to FIG. 3, the graphical arrangement of information on the display screen 10 provides a trip overview. In the graphical arrangement of information shown in FIG. 4, time information is given for locations and events that may be encountered along the calculated route. The driver's current position is graphically indicated by the vehicle icon on the left side of the display screen 10. The final destination is graphically indicated by a checkered flag or destination flag 40 on the right side of the display screen 10. The locations along the route, in this case San Francisco, Sacramento and South Tahoe, are textually indicated in an upper portion 80 of the display screen. The temperatures and pictograms 42 indicating weather conditions are provided below the respective location names. The temperatures along the route are also shown in the form of a basic line graph with the temperature plotted with a line 52. This provides a graphical overview of the temperatures such that a user can see relevant temperature information at a glance.

A further pictogram 44 indicates a traffic collision that has occurred between San Francisco and Sacramento. More specific information about the traffic collision is provided in a message window 84 located in a bottom portion 14 of the display screen 10. Information about the relative time, i.e. the estimated time duration to reach a respective location along the route, is provided in a lower portion 82 of the display screen 10. A vertical line visually connects a respective location name to the respective relative time wherein the location name in the upper portion 80 of the display screen and the corresponding time information in the lower portion 82 of the display screen 10 are aligned in a vertical direction. The display screen 10 of FIG. 4 further has a back button 46 for switching to a previous screen. A toggle button 48 is provided for selecting the trip information, also called travel route information, related to locations along the calculated route, such that a presentation of a relative time, a relative distance, and an absolute time can be selected. The toggle button 48 will allow the user to view specific information with respect to time and distance.

For example, FIG. 4 shows the relative time, i.e. the duration of travel required before the driver encounters specific weather conditions at specific locations along the route. By touching the toggle button 48, a driver can switch to a presentation of the relative distance, as shown in FIG. 5. The display screen 10 shown in FIG. 5 conveys for the most part the same information as the display screen shown in FIG. 4, however, in FIG. 5 the information is plotted according to the relative distance, i.e. the distance of travel required before the driver reaches specific locations or specific weather conditions. By actuating the toggle button 48 on the display screen 10, the specific weather information can also be plotted according to the time of day when the driver is expected to reach the respective events or locations. At the bottom right corner of the display screen 10 there is furthermore a map button 50 that allows switching to a map view of the calculated route. When the display screen displays a map view, the button 50 is labeled as a trip overview button allowing the user to switch back to the trip overview view.

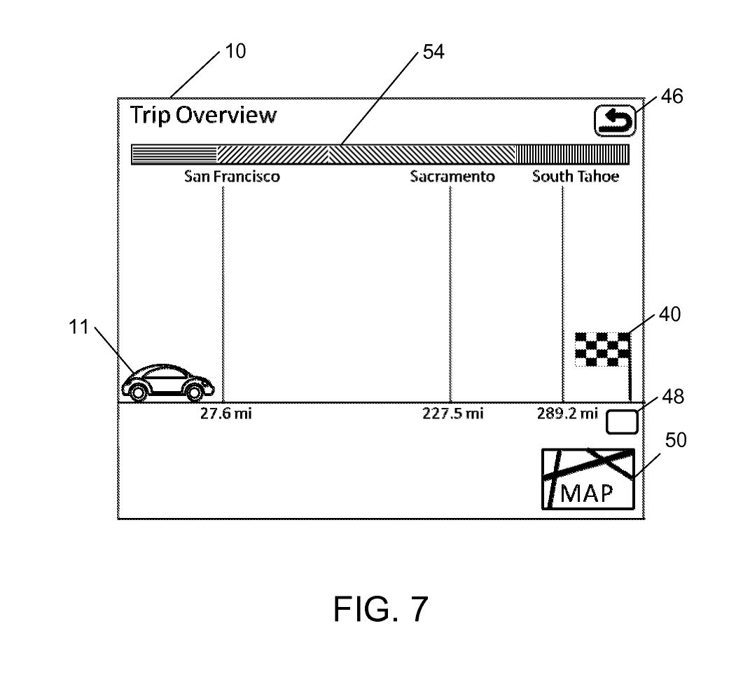

FIGS. 4 and 5 show in an exemplary manner how weather conditions can be graphically presented by using pictograms 42 and line graphs 52 such that a quick glance at the display screen 10 is sufficient to comprehend the information thereby minimizing driver distraction. FIG. 7 shows a display screen 10 which presents precipitation data in the form of a Doppler strip 54 that extends horizontally in a linear manner from the left side of the display screen to the right side of the display screen. The Doppler strip in FIG. 7 has different types of hatching in order to graphically indicate different precipitation intensities and/or different precipitation types. The precipitation intensities and/or precipitation types may alternatively be indicated by different graphical symbols, different shades of gray and are preferably indicated by different colors. The Doppler strip 54 is positioned directly above the location names such that, due to the proximity of a respective location name and the corresponding precipitation information, it is possible for a driver to quickly comprehend the weather information relevant for a given location.

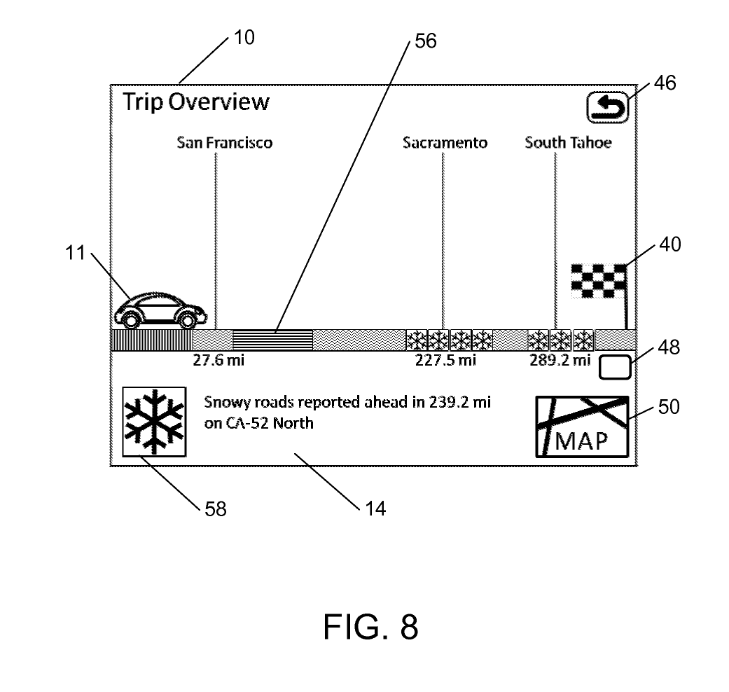

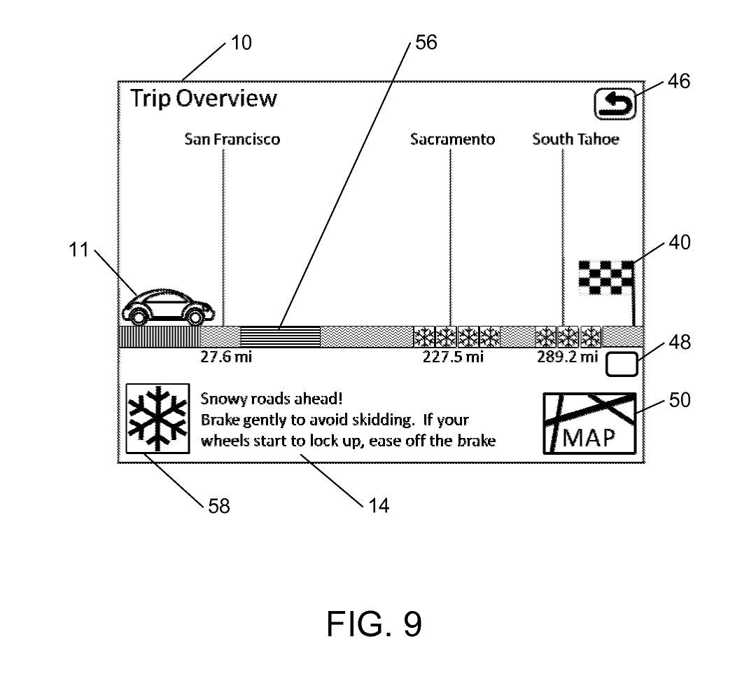

Further examples of types of information that can advantageously be plotted in a time-based linear manner similar to the example shown in FIG. 7 may include information related to road conditions such as icy, slippery, or snowy roads. FIG. 8 shows a display screen 10 which provides information about road conditions along the driver's route. The road conditions are presented as a strip 56 extending horizontally across the display screen 10. Different road conditions can be graphically presented through the use of different patterns, symbols, images or colors. For example, snowy road conditions can be graphically indicated by snowflakes. A message window in the bottom portion 14 of the display screen 10 provides a description of a road condition next to a graphical symbol 58 that indicates the road condition. FIG. 9 shows a display screen 10 similar to the display screen 10 shown in FIG. 8. The message window in the bottom portion 14 of the display screen 10 shown in FIG. 9 provides information about road conditions and additionally provides driving tips that are relevant for the road conditions.

Further examples of types of information and combinations of event information that can advantageously be plotted in a time-based linear manner may include information related to places such as points of interest, historic landmarks, tourist attractions, route landmarks and other landmarks. The information that is plotted in a time-based linear manner can also include events and happenings such as exhibitions, museum events, performances, concerts, movie theater events, social events, networking events, and even events related to other drivers or vehicles. The information on the display screen may include tips and information such as tourist information, driving tips for specific weather conditions or road conditions, and comments and tips for maximizing fuel economy.

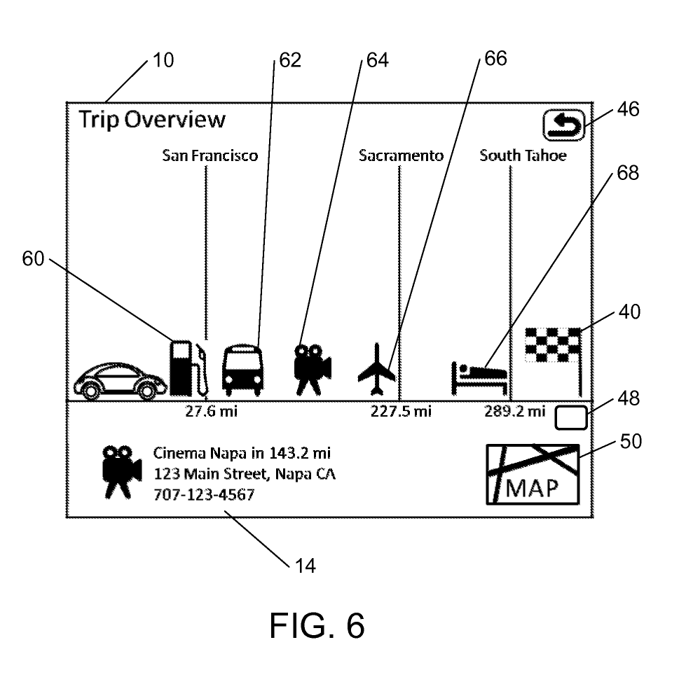

FIG. 6 shows an exemplary embodiment of a display screen 10 providing a trip overview with points of interests such as a gas station 60, a bus stop 62, a movie theater 64, an airport 66, and a hotel 68. A message window in the bottom portion 14 of the display screen 10 may provide more specific information about the points of interests. In FIG. 6, the message window provides contact information for the movie theater 64.

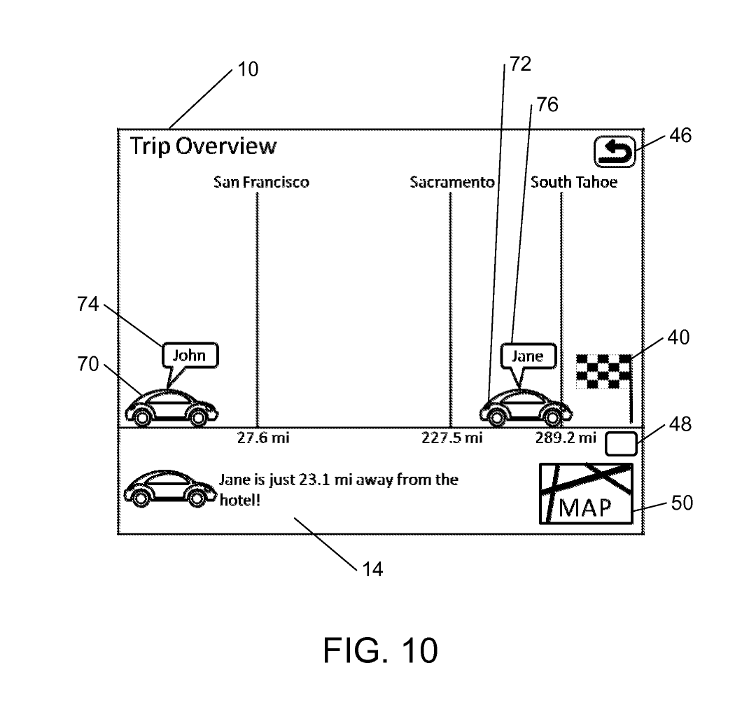

FIG. 10 shows an exemplary embodiment of a trip overview view for tracking vehicles on a route. In the example shown, the driver's vehicle is indicated by a vehicle icon 70 on the left side of the screen. Another vehicle driving on the route is indicated by a vehicle icon 72. The vehicle icons 70, 72 are labeled with name labels 74, 76 in order to identify the vehicles. In the example shown in FIG. 10, the display screen 10 presents a trip overview as it would be presented in John's vehicle. The vehicle icon 70 for John's vehicle is located on the left side of the screen at a position that represents John's current position on the route. Jane's vehicle is further ahead along the route and therefore the vehicle icon 76 representing Jane's vehicle is on the right side of the display screen 10. The message window in the bottom portion 14 of the display screen 10 provides specific information about Jane's vehicle. The tracking of vehicles along a route is of course not limited to two vehicles as is the case in FIG. 10. If more than two vehicles are to be tracked, additional icons for additional vehicles would be shown on the display screen 10.

The arrangement of the information related to a travel route is described in more detail with reference to FIG. 4. For the purpose of explaining the details of the trip overview view according to the invention, an X-axis and a Y-axis have been added in FIG. 4 in the form of dashed arrows. The X-axis and the Y-axis intersect at an origin indicating the current position of the vehicle. The X-axis extends horizontally. A scale graphic represents time and/or, if applicable, distance from the vehicle's current position (origin) to the destination or a location, wherein the time information is plotted in a linear manner along a horizontal direction. The toggle button 48 allows toggling the scale to show the time remaining for arrival at the location, the distance remaining to the location, or the time of arrival at the location. Weather and traffic data, road conditions, and events are plotted higher up on the Y-axis and move along the horizontal direction (X-axis direction) as a function of changes in distance and/or time. That is, this information slowly moves from right to left as the vehicle travels along the driver's planned route. In accordance with one embodiment, the information items can be statically placed on the screen in specific positions and the screen is updated in order to provide up to date information. However, instead of a static representation it is also possible to implement a dynamic representation. The movement of the plotted information can be rotated or reversed in order to feel intuitive for implementations in East Asian countries. Even though the direction of the X-axis may in principle be reversed, the drawings and the description of the drawings, provide only examples of time and distance information being plotted in accordance with a chronological order from left to right.

The landmark cities along the calculated route divide the trip into chunks in order to help the driver identify his or her own position in relation to the final destination and other indicated events along the route. Dividing the trip into such chunks is advantageous because information is better communicated when presented in small digestible units. Dividing up the trip information should prove especially useful for long trips because it provides an overview that is easy to comprehend. At the same time, listing landmark cities along the route informs the driver about his or her current position in relation to the landmark cities in a manner that can be easily and quickly comprehended by simply glancing at the display screen 10 as opposed to having to study and try to extract relevant information from a traditional map view. Presenting the landmark cities as shown in FIG. 4 also allows a driver to quickly see where he or she is going.

The upper portion 80 of the display screen 10 in FIG. 4, above the traffic information, features weather condition data for the landmark cities along the current travel route. The weather information includes icons or pictograms 42 for the weather condition (e.g., sunny, rainy, cloudy, foggy etc.), a temperature indicator, and a temperature line 52 that connects all temperature points. The lower portion 82 of the display screen 10 includes a vehicle icon 11 at the origin, which is defined by the X-axis and the Y-axis. The vehicle icon 11 serves as a cursor to represent the driver's current position on the diagram. The destination flag 40 at the right end of the X-axis represents the relative time/distance of the final destination for the calculated route. A message window 84 at the bottom 14 of the display screen 10 serves as an information repository for on-demand details. For example, traffic information is provided as a message in the message window 84 upon a user request.

An advantageous feature of the method of presenting trip overview information is that graphical elements on the display screen 10 are configured as selectable graphical elements or so-called clickable elements. Selectable graphical elements are identified by the dashed line rectangles 90, 92 in FIG. 5. Assuming the display screen 10 is a touch-sensitive display screen, a user could select any of the selectable graphical elements 90, 92 by touching the display screen.

The traffic event icon 44 in FIG. 5 is a selectable graphical element 92 and, in response to touching the traffic event icon 44, the message window at the bottom portion of the display screen reveals specific information about the traffic event. By enclosing the specific event information in the message window at the bottom portion 14 of the display screen, it is possible to keep the trip overview that is displayed in the upper and lower portions 80, 82 of the display screen clean and simple.

The map button 50 is also a selectable graphical element and serves as a direct link to the standard navigation map view. Conversely, the standard navigation map view has a trip overview button that serves as a direct link back to the trip overview view as shown for example in FIG. 5. A user can thus conveniently switch between the trip overview view and the navigation map view with a single touch or single click.

If a vehicle is equipped with an infotainment system that receives weather data and that has a weather tool using a separate graphical user interface, the partial weather information used in the trip overview view can be linked with the weather tool and can offer direct access to the weather tool of the infotainment system. In order to link the partial weather information of the trip overview with the detailed weather information of the weather tool, the landmark cities serve as a link to the detailed weather information or other relevant information for that city. The detailed weather information is then displayed using the graphical user interface of the weather tool. As described with reference to FIG. 5, the link that allows viewing detailed weather information may be activated by touching the display screen 10 in the area of the landmark city or the weather pictogram.

The above-described display configuration and method for presenting trip overview information allows the driver to assess a current position according to locations and landmarks along a calculated route. The information that is present on the display screen 10 is not limited to the examples described above. Other examples of types of information and combinations of event information that can advantageously be plotted in a time-based linear manner may include information related to traffic, such as traffic flow, reported accidents on roads, construction zones, closed bridges, and detours. Information related to weather conditions may include current weather conditions and weather forecasts, specifically temperatures, precipitation, cloud cover, and wind conditions. Information related to weather conditions may further include information related to the environment such as allergy warnings, smog levels, pollen count, and an ultraviolet index. Information related to weather conditions may further include severe weather alerts.

The method for presenting trip information as described above merges and displays driver-relevant information along a calculated travel route. The method furthermore makes driver-relevant information more transparent and understandable by separating the driver-relevant information from the traditional two-dimensional navigation map display and presenting the driver-relevant information in a linear format. Merging driver-relevant information such as current and predicted weather conditions, traffic conditions, road conditions, and events with location data, such as stopovers, landmarks, and/or destinations, allows the driver to comprehend multiple pieces of information and how the pieces of information are associated with one another with just one glance at the display screen.

Further, by presenting driver-relevant information in the absence of a traditional two-dimensional navigation map it is possible to discard superfluous information from the driver's view. Nevertheless, the trip overview view can integrate useful information that pertains to a driver's calculated route, such as smog levels, road conditions, points of interest and landmarks. As a result of eliminating superfluous information and presenting driver-relevant information in the manner described with reference to the drawings, it is no longer necessary to visually scan and process non-essential information in order to find the essential information for the task at hand. A driver can thus quickly and easily identify the relative locations of weather and traffic events on a current route of travel in terms of time and/or distance. Driver distraction is therefore reduced.

1. A method for displaying a travel route, the method which comprises:
providing a display screen in a vehicle, the display screen defining a first direction and a second direction, the first direction extending substantially horizontally, the second direction extending substantially perpendicular to the first direction;
plotting, in a first portion of the display screen, location names in a linear manner along the first direction, wherein the first portion of the display screen extends horizontally across the display screen;
plotting a travel route in a linear manner in a second portion of the display screen by plotting items of travel route information in a linear manner along the first direction, wherein a respective one of the location names in the first portion of the display screen and a respective one of the items of travel route information in the second portion of the display screen are aligned in the second direction, wherein the second portion of the display screen extends horizontally across the display screen and wherein the travel route information is selected from the group consisting of time information and distance information;
displaying a graphical symbol for the vehicle in the second portion of the display screen such that a position of the graphical symbol for the vehicle indicates a current position of the vehicle along the travel route; and
updating the location names and the travel route information as the vehicle travels along the travel route.

2. The method according to claim 1, which comprises:
providing the first portion of the display screen as an upper portion of the display screen and providing the second portion of the display screen as a lower portion of the display screen such that the upper portion of the display screen and the lower portion of the display screen extend adjacent one another horizontally across the display screen; and
providing a message window in a bottom portion of the display screen, wherein the bottom portion of the display screen is located below the lower portion of the display screen.

3. The method according to claim 1, which comprises:
plotting the travel route by plotting the items of travel route information in a linear manner from left to right horizontally across the second portion of the display screen;
displaying the graphical symbol for the vehicle at a fixed position on a left side of the second portion of the display screen; and
moving the location names in the first portion of the display screen from right to left as the vehicle travels along the travel route.

4. The method according to claim 1, which comprises:
displaying a graphical symbol for an event related to the travel route, the event being selected from the group consisting of a traffic-related event, a weather-related event, an environmental event, a road condition, a point of interest, and a happening; and
positioning the graphical symbol for the event in accordance with a time information or a distance information associated with the event.

5. The method according to claim 4, which comprises:
providing the display screen as a touch-sensitive display screen;
providing the graphical symbol for the event as a touch-selectable graphical symbol on the display screen; and
displaying detail information about the event in response to the touch-selectable graphical symbol being selected, wherein the detail information is displayed in a message window in a bottom portion of the display screen, and wherein the bottom portion of the display screen is located below the lower portion of the display screen.

6. The method according to claim 1, which comprises:
providing the display screen as a touch-sensitive display screen;
displaying a graphical symbol indicative of a weather condition at a given location along the travel route, wherein the graphical symbol indicative of the weather condition is placed adjacent to a corresponding one of the location names in the first portion of the display screen;
providing at least one of the graphical symbol indicative of the weather condition and the corresponding one of the location names as a touch-selectable region on the display screen; and
displaying detailed weather information in response to the touch-selectable region on the display screen being selected.

7. The method according to claim 1, which comprises displaying, as the travel route information plotted in the second portion of the display screen, a relative time to reach a location along the travel route, wherein the relative time to reach the location and a corresponding one of the location names are aligned in the second direction.

8. The method according to claim 1, which comprises displaying, as the travel route information plotted in the second portion of the display screen, a relative distance to reach a location along the travel route, wherein the relative distance to reach the location and a corresponding one of the location names are aligned in the second direction.

9. The method according to claim 1, which comprises tracking a position of a further vehicle traveling along the travel route by displaying a graphical symbol for the further vehicle such that a corresponding one of the items of travel route information and the graphical symbol for the further vehicle are aligned in the second direction.

10. The method according to claim 1, which comprises
displaying a graphical symbol for indicating travel route conditions, the travel route conditions being selected from the group consisting of road conditions and weather conditions; and
providing the graphical symbol for the travel route conditions as a continuous band extending horizontally across the display screen such that respective sections of the continuous band indicate respective travel route conditions along respective sections of the travel route.

11. The method according to claim 1, which comprises plotting the travel route in a linear manner, wherein the travel route is presented in absence of a two-dimensional navigation map on the display screen.

12. The method according to claim 1, which comprises:
providing a further display screen in the vehicle, wherein the further display screen is located in an instrument cluster; and
displaying turn-by-turn directions on the further display screen.

13. The method according to claim 1, which comprises using, as the display screen provided in the vehicle, a factory-installed display screen.

14. The method according to claim 1, which comprises using, as the display screen provided in the vehicle, a display screen of a portable navigation device.
